(19) United States
(12) Patent Application Publication
(10) Pub. No.: US 2023/0362630 A1
(43) Pub. Date: Nov. 9, 2023

(54) DATA COMMUNICATION SYSTEM AND METHOD FOR PROVIDING END-TO-END CIPHERING

(71) Applicant: Augnet Limited, Virginia Water (GB)

(72) Inventors: Daniel GILL, Virginia Water (GB); Jekaterina ORLOVA, Virginia Water (GB); Jakub STACHOWSKI, Virginia Water (GB)

(21) Appl. No.: 17/780,659

(22) PCT Filed: Nov. 30, 2020
(86) PCT No.: PCT/IB2020/061267

§ 371 Date: May 27, 2022

(30) Foreign Application Priority Data
Nov. 28, 2019 (GB) 1917362.4

(51) Int. Cl. H04W 12/033; H04W 4/14; H04L 9/08; H04L 9/14

(52) U.S. Cl. CPC H04W 12/033; H04W 4/14; H04L 9/0894; H04L 9/14

(57) ABSTRACT

A data communication system that sends SMS communications that are end-to-end ciphered when communicated from first device to second device. The data payloads of SMS communications are hard-encrypted by layers at first device. Each layer is combination of encryption function and obfuscation function. A data map is associated with layers and is provided in SMS message from first device to second device. The data map provides information about combination in each layer to enable inverse layer-by-layer decryption and de-obfuscation of hard-encrypted data payloads at second device. The second device has key wallet in which encryption function are defined according to first index, and obfuscation function are defined according to second index. The data map includes references to first and second index such that second device requires use of key wallet to interpret indices to enable inverse layer-by-layer decryption and de-obfuscation of hard-encrypted data payloads communicated to second device. Optionally, the first device is a mobile telephone of a given user, and the second device is implemented as a server of a banking, governmental institution or financial institution, wherein the end-to-end ciphered SMS communications include financial transaction instructions, PIN codes, passwords, reset codes and so forth.

### TECHNICAL FIELD

The present disclosure relates to data communication systems that, when in operation, securely communicate short text messages, for example in a manner of short messaging services (SMS), wherein an end-to-end ciphering is maintained for the communicated messages; for example, the data communication systems communicate such short text messages to mobile communication devices and from mobile communication devices. Moreover, the present disclosure relates to methods of (for) operating aforementioned data communication systems to communicate securely short text messages, for example in a manner of short messaging services (SMS) by end-to-end ciphering of the messages. Furthermore, the present disclosure relates to computer program products comprising a non-transitory computer-readable storage medium having computer-readable instructions stored thereon, the computer-readable instructions being executable by a computerized device comprising processing hardware for executing aforementioned methods.

### BACKGROUND

In overview, data communication systems that operate to communicate short text messages, for example short messaging services (SMS) communications, to mobile communication devices such as mobile telephones, for example smart phones, have been known for many years. On account of widespread use of SMS, it has become a widely established standard. SMS is a text messaging service component of most mobile telephones and associated with the World Wide Web (WWW). The text messaging service uses standardized communication protocols to enable mobile devices to exchange short text messages. In year 2010, software applications supporting SMS communication were the most widely used data applications (“Apps”), with an estimated 3.5 billion active users, or about 80% of all mobile subscribers. SMS, as used on modern communication devices, originated from radio telegraphy in radio memo pagers that used standardized phone protocols. These were defined in year 1985 as part of the Global System for Mobile Communications (GSM) series of standards. The protocols allowed users to send and receive messages of up to 160 alpha-numeric characters to and from GSM mobiles.

Typically, transmission of short messages between a Short Message Service Center (SMSC) and a given user equipment (e.g. a smartphone) is done whenever using the Mobile Application Part (MAP) of the Signalling System No. 7 (SS7) protocol. The short messages are sent with the Mobile Application Part mobile originating (MAP MO-) and MT-ForwardSM operations, whose payload length is limited by constraints of the signalling protocol to precisely 140 bytes (140 bytes*8 bits/byte=1120 bits). The short messages can be encoded using a variety of alphabets: the default GSM 7-bit alphabet, the 8-bit data alphabet, and the 16-bit UCS-2 alphabet. Depending on which alphabet a given subscriber has configured in his/her user equipment (e.g. mobile device), this leads to the maximum individual short message sizes of 160 7-bit characters, 140 8-bit characters, or 70 16-bit characters. GSM 7-bit alphabet support is mandatory for GSM handsets and network elements, but characters in languages such as Hindi, Arabic, Chinese, Korean, Japanese, or Cyrillic alphabet languages (for example, Russian, Ukrainian, Serbian, Bulgarian, etc.) must be encoded using the 16-bit Universal Coded Character Set-2 (UCS-2) character encoding (see Unicode). Routing data and other metadata is additional to the payload size.

Moreover, larger content (concatenated SMS, multipart or segmented SMS, or “long SMS”) can be sent using multiple messages, in which case each message usually starts with a User Data Header (UDH) containing segmentation information. SMS gateway providers facilitate SMS traffic between businesses and mobile subscribers, including SMS for enterprises, content delivery, and entertainment services involving SMS, for example television (TV) voting. Considering SMS messaging performance and cost, as well as the level of messaging services, SMS gateway providers can be classified as aggregators or SS7 providers. Message Service Centres communicate with the Public Land Mobile Network (PLMN) or Public Switched Telephone Network (PSTN) via Interworking and Gateway Mobile Switching Centres (MSCs). Subscriber-originated messages are transported from a handset to a service centre, and may be destined for mobile users, subscribers on a fixed network, or Value-Added Service Providers (VASPs), also known as application-terminated. Subscriber-terminated messages are transported from the service centre (center) to the destination handset, and may originate from mobile users, from fixed network subscribers, or from other sources such as VASPs. On some carriers, non-subscribers can send messages to a subscriber's phone using an Email-to-SMS gateway. Additionally, many carriers, including American Telephone & Telegraph Company (AT&T®) Mobility, T-Mobile USA, Sprint®, and Verizon® Wireless, offer the ability to do this through their respective web sites. Text-enabled fixed-line handsets are required to receive messages in a text format. However, messages can be delivered to non-enabled mobile phones using text-to-speech conversion.

SMS is also used for M2M (Machine-to-Machine) communication. For example, there is a Light Emitting Diode (LED) display machine controlled by SMS, and some vehicle tracking companies use SMS for their data transport or telemetry needs. Short messages may be used normally to provide premium rate services to subscribers of a telephone network. Mobile-terminated short messages can be used to deliver digital content such as news alerts, financial information, such as transactions, logos, and ring tones.

Furthermore, application-to-person (A2P) SMS is known. While SMS reached its popularity as a person-to-person messaging service, another type of SMS is growing fast: application-to-person (A2P) messaging services. A2P is a type of SMS sent from a subscriber to an application or sent from an application to a subscriber. It is commonly used by financial institutions, airlines, hotel booking sites, social networks, and other organizations sending SMS from their systems to their customers. In the USA, A2P messages must be sent using a short code rather than a standard long code.

Next, conventional SMS delivery will be described. When the aforementioned Short Message Service Centre (SMSC) determines it needs to attempt to deliver a Short Message to its intended destination, it will send the SMS-PP APDU containing the text message, a “B-Party” (destination phone number) and other details to the Gateway MSC (GMSC) logical component on the SMSC. The GMSC, on receipt of this Short Message, needs to discover the location of the B-Party in order to be able to correctly deliver the text to the recipient (the term Gateway MSC, in this context, indicating an MSC that is obtaining routing information from the Home Location Register (HLR)). To do this, the GMSC invokes the Mobile Application Part (MAP) service package MAP_SEND_ROUTING_INFO_FOR_SM, which sends a sendRoutinglnfoForSM (SRI-for-SM) MAP message to the destination number's HLR, requesting their present location. This SRI-for-SM message may be sent to an HLR in the same network as the SMSC, or via an interconnect to an HLR in a foreign PLMN, depending on which network the destination subscriber belongs to. The HLR performs a database lookup to retrieve the B-Party's current location, and returns it in an acknowledgement message to the SMSC's GMSC entity. The current location may be the MSC address the subscriber is currently roaming on, the SGSN address, or both. The HLR may also return a failure, if it considers the destination to be unavailable for short messaging; see the Failed Short Message delivery section as elucidated below. Having obtained the routing information from the HLR, the GMSC will attempt to deliver the Short Message to its recipient. This is done by invoking the MAP_MT_FORWARD_SHORT_MESSAGE service, which sends a MAP mt-ForwardSM message to the address returned by the HLR, regardless of whether it is an MSC (Circuit Switched SMS delivery) or an SGSN (Packet Switched SMS delivery).

The Visited Mobile Switching Centre (VMSC) will request the information needed for it to deliver the Short Message to its recipient by sending a Send_Info_for_MT_SMS message to the Visitor Location Register (VLR). The VLR will then instigate a page request, or subscriber search, for the destination subscribers Mobile Subscriber Integrated Services Digital Network (ISDN) Number (MSISDN), and return the result to the VMSC. Since a typical deployment sees the VLR being co-located with the MSC, this message flow is usually internal to the platform. Should the page or search for the subscriber fail, the VLR will indicate the failure cause to the VMSC, which will abort the Short Message delivery procedure and return the failure to the SMSC (see the Failed Short Message delivery as elucidated below). If the page of the handset were successful, the VMSC would then send to the SMSC indicating successful delivery. The GMSC component of the SMSC passes the result of the delivery attempt to the Service Centre. In the case of successful delivery, the delivered text message will be removed from the Store and Forward Engine (SFE) and, if requested, a delivery report sent to the text originator. If the delivery failed, the SMSC invokes a retry procedure to make periodically further attempts at delivery; additionally, it may register with the HLR to receive a notification when the B-Party becomes available for Short Message delivery in the future (see the Failed Short Message delivery as elucidated below).

Next, failed Short Message delivery will be elucidated in greater detail. When the VMSC/SGSN indicates a Short Message delivery failure, the SMSC may send a message to the HLR, using the MAP_REPORT_SM_DELIVERY_STATUS procedure, indicating the reason for the delivery failure and requesting that the SMSC be put on a list of service centres wanting to be notified when the destination party becomes available again. The HLR will set a flag against the destination account, indicating that it is unavailable for short message delivery, and store the SMSC's address in the Message Waiting Data (MWD) list for the destination party. Valid flags are Mobile Not Reachable Flag (MNRF), Memory Capacity Exceeded Flag (MCEF) and Mobile Not Reachable for GPRS (MNRG). The HLR will now start responding to SRI-for-SM requests with a failure, indicating the failure reason, and will automatically add the requesting SMSC's address to the MWD list for the destination party. (However, if the SRI-for-SM message has priority flag set then the HLR will reply with VLR address if available).

The HLR may be informed of a subscriber becoming available for Short Message delivery in several ways:
(i) Where the subscriber has been detached from the network, a reattach will trigger a Location Update to the HLR.
(ii) Where the subscriber has been out of coverage, but not fully detached from the network, on coming back into coverage it will respond to page requests from the Visitor Location Register (VLR). The VLR will then send a Ready-for-SM (mobile present) message to the HLR.
(iii) Where the MS has had its memory full, and the subscriber deletes some texts, a Ready-for-SM (memory available) message is sent from the VMSC/VLR to the HLR.

Upon receipt of an indication that the destination party is now ready to receive short messages, the HLR sends an AlertSC MAP message to each of the SMSCs registered in the MWD list for the subscriber, causing the SMSC to start the Short Message delivery process again, from the beginning. Additionally, the SMSC will go into a retry schedule, attempting to deliver periodically the SM without getting an alert. The retry schedule interval will depend on the original failure cause—transient network failures will result in a short retry schedule, whereas out of coverage will typically result in a longer schedule.

Many SMS messages are susceptible to being intercepted when being transmitted from a given sender to a given recipient. Such interception is problematic when the SMS messages include sensitive information, for example passwords, access codes, PIN numbers, medical records, and personal information. When sensitive data is to be transmitted, it is conventional practice to employ encryption, but powerful contemporary computing engines (“super-computers”) are now capable of breaking data encryption. Therefore, there exists a contemporary problem of how to protect SMS messages in an end-to-end manner that is resistant to hacking by malicious third parties.

Various types of encryption are known, for example private-public key encryption, but such types of encryption are no longer sufficiently secure due to aforementioned powerful contemporary computing engines (“super-computers”). Recently, for example, a “one-time pad” encrypted messaging service has gained attention. However, it is observed that one-time pad encrypted messaging service requires considerable amount of messaging and data exchange to achieve its goal, i.e., communication of encrypted messages, which increases the network load and is thus not desirable. Moreover, the risk to be affected by malicious code is still high in such conventional systems.

In some conventional systems, a “one-time pad” encrypted messaging service is used. However, the “one-time pad” messaging service has many limitations associated therewith. The “one-time pad” messaging service, such as Zendo®, requires a given user to meet another user with whom the given user needs to initiate a communication. The given user, upon meeting the other user, needs to scan a quick response (QR) code or a barcode for authentication. Notably, such a barcode provides an on-boarding barrier as users need to add gradually other users only when they meet up with them in real life.

Therefore, in light of the foregoing discussion, there exists a need to overcome the aforementioned drawbacks associated with the conventional messaging services.

### SUMMARY

The present disclosure seeks to provide an improved data communication system that is able to communicate SMS service messages more securely using end-to-end ciphering in a multi-layered security mechanism. The present disclosure also seeks to provide an improved method of (namely method for) operating an improved data communication system to communicate SMS service messages more securely using end-to-end ciphering in a multi-layered security mechanism. The present disclosure seeks to provide a solution to the existing problem of insecure and vulnerable SMS communication. An aim of the present disclosure is to provide a solution that overcomes at least partially the problems encountered in prior art, and provide a data communication system that is able to communicate hard-encrypted SMS service messages between one or more devices that is fail-safe and extremely difficult to decipher (i.e. almost uncrackable) by unauthorised third parties, thereby ensuring highly secured and reliable SMS communication between the one or more communication devices.

In one aspect, an embodiment of the present disclosure provides a data communication system that, when in operation, sends short messaging service (SMS) communications to one or more devices,

characterized in that
the SMS communications are end-to-end ciphered in the data communication system when communicated from a first given device to a second given device,
   wherein data payloads of at least a subset of the SMS communications are hard-encrypted by a plurality of layers at the first given device, wherein each layer of the plurality of layers is a combination of an encryption function and an obfuscation function, and
   wherein a data map is associated with the plurality of layers and is provided in a SMS message from the first given device to the second given device, and
   wherein the data map provides information indicative of the combination in each layer of the plurality of layers to enable corresponding inverse layer-by-layer decryption and de-obfuscation of the hard-encrypted data payloads of the SMS messages at the second given device, and
   wherein the second given device has a key wallet in which the encryption function in each layer of the plurality of layers are defined according to a first index, and the obfuscation function in each layer are defined according to a second index, and
   wherein the data map further includes references to the first index and the second index such that the given second device requires use of the key wallet to interpret the first index and second index to enable the corresponding inverse layer-by-layer decryption and de-obfuscation of the hard-encrypted data payloads of the SMS messages communicated to the second given device.

Optionally, the first device is a mobile telephone of a given user, and the second device is implemented as a server of a banking, governmental or financial institution, wherein the end-to-end ciphered SMS communications include at least one of: financial transaction instructions, PIN codes, password, password resets.

Optionally, implementing the data communication system in combination with a mobile communication device (for example, a smart phone) includes providing executable software in the mobile communication device to process the end-to-end ciphered SMS communications, wherein the executable software is an integral part of an operating system (for example, Android®, iPhone OS, MeeGo OS, Symbian OS, webOS, Blackberry OS) of the mobile communication device.

In another aspect, an embodiment of the present disclosure provides a method of (namely method for) operating a data communication system to send conventional short messaging service (“SMS”) communications to one or more devices,

characterized in that the method includes:
arranging for the SMS service communications to be end-to-end ciphered in the data communication system when communicated from a first given device to a second given device, wherein the SMS service communications are end-to-end ciphered by:
(i) hard-encrypting, by use of a plurality of layers at the first given device, data payloads of at least a subset of the SMS communications, wherein each layer is a combination of an encryption function and an obfuscation function;
(ii) associating, a data map with the plurality of layers and providing the data map in a SMS message from the first given device to the second given device;
(iii) providing, by use of the data map, information indicative of the combination in each layer of the plurality of layers to enable corresponding inverse layer-by-layer decryption and de-obfuscation of the hard-encrypted data payloads of the SMS messages at the second given device;
(iv) defining the encryption function in each layer of the plurality of layers according to a first index, and the obfuscation function in each layer according to a second index of a key wallet in the second given device, and
(v) enabling the corresponding inverse layer-by-layer decryption and de-obfuscation of the hard-encrypted data payloads of the SMS messages communicated to the second given device, by use of the data map that further includes references to the first index and the second index such that the given second device requires use of the key wallet to interpret the first index and second index.

Optionally, the first device is a mobile telephone of a given user, and the second device is implemented as a server of a banking, governmental or financial institution, wherein the end-to-end ciphered SMS communications include at least one of: financial transaction instructions, PIN codes, passwords, password resets.

Optionally, implementing the data communication system in combination with a mobile communication device (for example, a smart phone) includes providing executable software in the mobile communication device to process the end-to-end ciphered SMS communications, wherein the executable software is an integral part of an operating system (for example, Android®, iPhone OS, MeeGo OS, Symbian OS, webOS, Blackberry OS) of the mobile communication device.

In yet another aspect, an embodiment of the present disclosure provides a computer program product comprising a non-transitory computer-readable storage medium having computer-readable instructions stored thereon, the computer-readable instructions being executable by a computerized device comprising processing hardware to execute the aforementioned method.

Embodiments of the present disclosure substantially eliminate or at least partially address the aforementioned problems in the prior art, and enable well-established SMS service messages to communicate data in an ultra-secure manner by employing hard encryption of their data payloads while using widespread contemporary communication infrastructure that is suitable for SMS messaging purposes.

Additional aspects, advantages, features and objects of the present disclosure would be made apparent from the drawings and the detailed description of the illustrative embodiments construed in conjunction with the appended claims that follow.

It will be appreciated that features of the present disclosure are susceptible to being combined in various combinations without departing from the scope of the present disclosure as defined by the appended claims.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those skilled in the art will understand that the drawings are not to scale. Wherever possible, like elements have been indicated by identical numbers.

Embodiments of the present disclosure will now be described, by way of example only, with reference to the following diagrams wherein:

FIG. 1 is an illustration of a prior art depicting conventional data communication system that communicates conventional SMS messages to user devices, in accordance with an embodiment of the present disclosure;

FIG. 2 is an illustration of a data communication system that securely communicates SMS messages to user devices, in accordance with an embodiment of the present disclosure;

FIG. 3 is a block diagram of a data communication system, in accordance with an embodiment of the present disclosure;

FIG. 4 is an illustration of the data communication system of FIG. 3, wherein hard-encrypted portions of an SMS message are communicated via a plurality of routes to reduce a risk of third-party eavesdropping; and

FIG. 5 is a flow chart of a method to operate a data communication system, in accordance with an embodiment of the present disclosure.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practising the present disclosure are also possible.

In one aspect, an embodiment of the present disclosure provides a data communication system that, when in operation, sends short messaging service (SMS) communications to one or more devices,

characterized in that
the SMS communications are end-to-end ciphered in the data communication system when communicated from a first given device to a second given device,
   wherein data payloads of at least a subset of the SMS communications are hard-encrypted by a plurality of layers at the first given device, wherein each layer is a combination of an encryption function and an obfuscation function, and
   wherein a data map is associated with the plurality of layers and is provided in a SMS message from the first given device to the second given device, and
   wherein the data map provides information indicative of the combination in each layer of the plurality of layers to enable corresponding inverse layer-by-layer decryption and de-obfuscation of the hard-encrypted data payloads of the SMS messages at the second given device, and
   wherein the second given device has a key wallet in which the encryption function in each layer of the plurality of layers are defined according to a first index, and the obfuscation function in each layer are defined according to a second index, and
   wherein the data map further includes references to the first index and the second index such that the given second device requires use of the key wallet to interpret the first index and second index to enable the corresponding inverse layer-by-layer decryption and de-obfuscation of the hard-encrypted data payloads of the SMS messages communicated to the second given device.

Optionally, the first device is a mobile telephone of a given user, and the second device is implemented as a server of a banking, governmental or financial institution, wherein the end-to-end ciphered SMS communications include financial transaction instructions, PIN codes, passwords, device resets and so forth. Optionally, the first device has a key wallet stored therein that is unique to the first device and identified by a reference code, and the second device also has a copy of the key wallet recorded together with the reference code. When the first device, namely mobile telephone, sends a hard-encrypted SMS communication pursuant to the present disclosure to the second device, namely the server, the reference code is included in a user data header (USD) sent from the first device to the second device, so that the second device is able to determine from the reference code of the user data header (USD) which key wallet to use when the second device decrypts and de-obfuscates the hard-encrypted SMS communication. The second device, namely server, potentially stores key wallets of a plurality of such first devices and selects which of the plurality of key wallets from the reference code. Such a manner of operation renders the server more robust to eavesdropping and malicious attach in an event that security of a given first device is breached and its key wallet become known to a malicious third party. Similar considerations pertain mutatis mutandis when the first device sends hard-encrypted SMS communication to the second device.

In another aspect, an embodiment of the present disclosure provides a method of (namely, method for) operating a data communication system to send conventional short messaging service (“SMS”) communications to one or more devices,

characterized in that the method includes:
arranging for the SMS service communications to be end-to-end ciphered in the data communication system when communicated from a first given device to a second given device, wherein the SMS service communications are end-to-end ciphered by:
(i) hard-encrypting, by use of a plurality of layers at the first given device, data payloads of at least a subset of the SMS communications, wherein each layer is a combination of an encryption function and an obfuscation function;
(ii) associating, a data map with the plurality of layers and providing the data map in a SMS message from the first given device to the second given device;
(iii) providing, by use of the data map, information indicative of the combination in each layer of the plurality of layers to enable corresponding inverse layer-by-layer decryption and de-obfuscation of the hard-encrypted data payloads of the SMS messages at the second given device;
(iv) defining the encryption function in each layer of the plurality of layers according to a first index, and the obfuscation function in each layer according to a second index of a key wallet in the second given device, and
(v) enabling the corresponding inverse layer-by-layer decryption and de-obfuscation of the hard-encrypted data payloads of the SMS messages communicated to the second given device, by use of the data map that further includes references to the first index and the second index such that the given second device requires use of the key wallet to interpret the first index and second index.

Optionally, in the method, the first device (S₁) is a mobile telephone of a given user, and the second device (R) is implemented as a server of a banking institution, a financial institution, a governmental institution, and similar, wherein the end-to-end ciphered SMS communications include financial transaction instructions, PIN codes, passwords, reset codes, sensitive personal private information and similar. Optionally, the first device S₁ has a key wallet stored therein that is unique to the first device S₁ and identified by a reference code K₁, and the second device R also has a copy of the key wallet recorded together with the reference code K₁. When the first device S₁, namely mobile telephone, sends a hard-encrypted SMS communication pursuant to the present disclosure to the second device R, namely the server, the reference code K₁ is included in a user data header (USD) sent from the first device S₁ to the second device R, so that the second device R is able to determine from the reference code K₁ included in the user data header (USD) which key wallet to use when the second device R decrypts and de-obfuscates the hard-encrypted SMS communication. The second device R, namely server, potentially stores key wallets of a plurality of such first devices Sₙ and selects which of the plurality of key wallets from the reference code Kₙ. Such a manner of operation renders the server more robust to eavesdropping and malicious attach in an event that security of the given first device S₁ is breached and its key wallet become known to a malicious third party. Moreover, such a manner of operation is a very close approximation to a “one time pad” which is regarded as a highest degree of data protection that is feasible.

In yet another aspect, an embodiment of the present disclosure provides a computer program product comprising a non-transitory computer-readable storage medium having computer-readable instructions stored thereon, the computer-readable instructions being executable by a computerized device comprising processing hardware to execute the aforementioned method.

The present disclosure provides a data communication system that, when in operation, sends SMS communications from a sending device to one or more receiving devices; optionally, the one or more receiving devices include a server, for example when the sending device communicates to a server of a financial institution, a banking institution, a governmental institution and similar, to instruct a financial transaction or similar to be implemented, for example to transfer funds or to pay and invoice or bill. Such a data communication system accommodates SMS communications that are end-to-end ciphered in the data communication system when communicated from the first given device to the second given device. In contradistinction to conventional systems, where the SMS messages are susceptible to being intercepted when being transmitted from a given sender to a given recipient, the present disclosure provides the data communication system that allows hard-encrypted SMS communication, wherein the SMS communication is ciphered in a multi-layered mechanism. In some conventional systems, a “one-time pad” encrypted messaging service is used. However, the “one-time pad” messaging service has many limitations associated therewith. The “one-time pad” messaging service, such as Zendo®, requires each user to meet another user with whom the user needs to initiate a communication. The user, upon meeting the other user needs to scan a quick response (QR) code or a barcode for authentication. Notably, such a barcode provides an on-boarding barrier as users need to add other users gradually only when they meet up with them in real life. Conversely, the data communication system of the present disclosure allows the users to initiate a secure SMS communication with any user, for example a private user or a server of a financial institution, without the explicit need of having to meet them in person. Furthermore, in Zendo®, the barcodes may be used by miscreants to inject potential malicious code that potentially hampers the security of the SMS communication. Moreover, the conventional “one-time pad” messaging services requires generation of a “pad” or a code that needs to be of same length or “bits”, as that of an original SMS message string. Thus, such “one-time pad” requires a large amount of data exchange to achieve the “one time pad”. In contradistinction to the conventional systems, the data communication system of the present disclosure is very data light (i.e. low network load) and does not require extensive pre-communication of messages to send hard-encrypted data that are encrypted using a multi-layered mechanism (e.g. the aforementioned plurality of layers) and may not require such barcodes where the security of the SMS communication is potentially compromised. The data communication system of the present disclosure uses a layered encryption and obfuscation approach, wherein deciphering of the SMS communications as well as the decryption functions and the de-obfuscation functions is possible only for a desired recipient that has the key wallet. Even if the unauthorised user is able to decipher one layer of information, the unauthorised user still cannot decipher the SMS communications unless the unauthorised user deciphers each layer of the plurality of layers, which is almost uncrackable and thus fail-safe. Moreover, a key wallet in which the encryption function in each layer are defined according to a first index, and the obfuscation function in each layer are defined according to a second index are stored in the second given device in an encrypted form or in a secured physical area of data memory, or a combination of both. Thus, access to the key wallet comprising information associated with the encryption functions and obfuscation functions is almost not feasible to achieve. Hence, the present disclosure provides the data communication system that sends hard-encrypted SMS communications to one or more devices that is ciphered across end-to-end networks, thereby, enabling secure, reliable and fail-safe SMS communications.

In overview, the present disclosure is concerned with SMS messaging that has become a well-established standard in many parts of the world. However, conventional SMS messages are susceptible to being intercepted between a given sender and a given intended recipient, and conventionally provide a poor degree of data security. Typically, such interception can potentially be secured (i.e. rendered useless) by sending encrypted data as a data payload of an SMS message, wherein:
(i) the given sender encrypts data to be communicated to generate corresponding encrypted data; E(D), wherein D is data payload and E is an encryption function;
(ii) the given sender formats the encrypted data as a data payload of an SMS message to provide a corresponding encrypted SMS; SMS[F[E9D)]], wherein F is a formatting function and SMS;
(iii) the encrypted SMS message, for example SMS[F[E9D)]] is communicated via a data communication network to the given recipient; and
(iv) the given recipient extracts the encrypted data payload of the encrypted SMS message, and then decrypts the encrypted data payload; in other words, D=E−1[F−1[SMS[F[E9D)]]].

Encryption and decryption in the steps (i) and (iv), respectively, either requires:
(a) encryption and decryption functions to be predefined in devices of the given sender and given recipient, for example selected from a library of encryption and decryption functions, for example with associated encryption and decryption keys; or
(b) a defined encryption and decryption function employed with associated decryption key being communicated to the given recipient, or the given recipient having a pre-defined key wallet where there is communicated a reference index from the sender to the recipient that is used to access an appropriate decryption key of the key wallet; or
(c) a combination of (a) and (b).

Beneficially, the key wallet is native to the recipient and never communicated via the data communication network. Optionally, when the key wallet has to be communicated within the data communication network, proprietary encrypted security data containers are beneficially employed, for example as provided by Trustonic® Ltd. (Cambridge, UK) (see https://www.trustonic.com/solutions/patents/). Such an approach provides an enhanced degree of protection to the data payload, but is still susceptible to being hacked using powerful supercomputer computing engines. However, the present disclosure provides embodiments that provide for very “hard” encryption of SMS messages that even the most powerful supercomputers of national security authorities would not be able to decrypt. Optionally, the key wallet is generated from executable software included within the given recipient, wherein the executable software is executed on initial registration of the given recipient. Optionally, the key wallet is regenerated in a modified form when the recipient (device) is reset, for example in an event that it is suspected that the recipient (device) has become compromised regarding its security.

Optionally, implementing the data communication system in combination with a mobile communication device (for example, a smart phone) includes providing executable software in the mobile communication device to process the end-to-end ciphered SMS communications, wherein the executable software is an integral part of an operating system (for example, Android®, iPhone OS, MeeGo OS, Symbian OS, webOS, Blackberry OS) of the mobile communication device.

Optionally, on receipt of a hard-encrypted SMS communication at the recipient and successfully, the recipient sends an acknowledgement receipt back to the given sender. In an event that the hard-encrypted SMS communication is sent from the given sender and there is a lack of the acknowledgement receipt from the given recipient, the given sender deduces therefrom that the given recipient has been unable to decrypt and de-obfuscate the hard-encrypted SMS communication. In such a situation, the given sender optionally invokes a reset of the given recipient, for example by sending a standard SMS requesting the given recipient to reset and regenerate its key wallet. Alternatively, or additionally, the given sender optionally sends a standard SMS message to the given recipient regarding highlighting potential problems with executing deciphering successfully.

The present disclosure provides a data communication system that, when in operation, sends short messaging service (SMS) communications to one or more devices (for example from a sending device to a server of a banking institution), characterized in that the SMS communications are end-to-end ciphered in the data communication system when communicated from a first given device to a second given device; the first given device is optionally a mobile telephone and the second given user device is a server of a banking institution). The end-to-end ciphered SMS communications allow access to the SMS only to users of the first given device and the second given device, thereby enabling secure SMS communication across end-to-end (e-2-e) networks. The end-to-end ciphering refers to ciphering of SMS communications from the time such SMS communications leave the first given device, passes through one or more network entities (e.g. cellular network), and finally arrives at the second given device (i.e. end-to-end security).

Moreover, the data payloads of at least a subset of the SMS communications are hard-encrypted by a plurality of layers at the first given device, wherein each layer is a combination of an encryption function and an obfuscation function. In an example, the data payloads of at least the subset of the SMS communications that are hard-encrypted potentially is the subset comprising sensitive information. The sensitive information is for example, banking details such as login credentials, account number of a bank of the user, transaction details, or other information. Embodiments of the present disclosure provide a multi-layered mechanism (or approach), i.e., the use of the plurality of layers to hard-encrypt the data. The given data payload is encrypted and then obfuscated; for example, hard-encrypted data Dh is generated by:

Dₕ=Oⱼ[Eᵢ[D]] Eq. 1

wherein
Eᵢ is an encryption function of type denoted by an index i; and
Oⱼ is an obfuscation function of type denoted by an index j.

Equation 1 (Eq. 1) represents one layer of hard encryption. However, a plurality of layers of hard encryption is used, for example as exemplified in equation Eq. 2:

Dₕ=O₃[E₃[O₂[E₂[O₁[E₁[D]]]] Eq. 2

According to an embodiment, the plurality of layers employs mutually different encryption functions or mutually different encryption keys, or both; optionally, encoding functions are employed in substitution of encryption functions, for example to provide data compression The encryption functions E of Eq. 2 are a same encryption function with same encryption keys, or are mutually different encryption functions with same encryption keys, or are mutually different encryption functions with mutually different keys. Examples of encryption function include, but are not limited to, RSA encryption, PGP encryption, public-private key encryption. When encoding is employed as an alternative to encryption, functions employed cn include Huffmann coding, arithmetic coding, Golomb coding, conditional Golomb coding, quantization coding, transform coding, unary coding, entropy encoding, predictive coding, and the like. Examples of obfuscation functions can include swapping nibbles of bytes according to an obfuscation template, selectively negating bits of bytes according to a bit mask or bit template, or re-arranging a plurality of data portions of a data payload(s) in a specified sequence that is different than a corresponding original sequence. Such obfuscation spreads information within a concatenated sequence of hard-encrypted SMS messages, such that a third party hacking a given layer of encryption has little indication that a given decryption algorithm being tested is iterating towards breaking the given layer of encryption.

According to an embodiment, the plurality of layers employ mutually different obfuscation functions or mutually different obfuscation templates, or both. The obfuscation functions O of Eq. 2 are a same obfuscation function with same bit manipulation function, or are mutually different obfuscation functions with same bit manipulations, or are mutually different obfuscation functions with mutually different bit manipulations. Definitions of the encryption functions and the obfuscation functions employed to generate the hard-encrypted data Dh are communicated in a data map from the given sender (i.e. first given device) to the given recipient (i.e. second given device).

Furthermore, a data map is associated with the plurality of layers and is provided in a SMS message from the first given device to the second given device. The data map provides information indicative of the combination in each layer of the plurality of layers to enable corresponding inverse layer-by-layer decryption and de-obfuscation of the hard-encrypted data payloads of the SMS messages at the second given device. The data map is sent by the first given device and the data map includes information that is potentially used by the second given device to decrypt and de-obfuscate the hard-encrypted data payloads of the SMS messages. For example, let's say an encryption function A1 and obfuscation function B1 is applied in layer 1. Similarly, encryption function A2 and obfuscation function B2 is applied in layer 2. Thus, in the inverse layer-by-layer decryption and de-obfuscation, first inverse of encryption function A2 and obfuscation function B2 is applied followed by inverse of corresponding encryption function A1 and obfuscation function B1 to derive original payload(s) for user consumption.

According to an embodiment, each layer of the plurality of layers employs a combination of the encryption function, the obfuscation function, and further an error detection function, for example employing a check-sum algorithm, wherein the data map provides information indicative of the combination that includes the encryption function, the obfuscation function, and further the error detection function in one or more, for example in each layer, of the plurality of cascading layers to enable corresponding inverse layer-by-layer decryption, de-obfuscation, and a error detection function check of the hard-encrypted data payloads of the SMS communications at the second given device. Optionally, inclusion of the error detection function enables transmission errors to be detected, and also correction of the transmissions errors to be achieved at the second given device; when the check-sum is indicating an error has occurred, a correct form of the data payload can be inferred from the parity bit value. The messages in a SMS communication are susceptible to noise and network disturbances, thus, the data payload may get corrupted. The error detection function is configured to detect such an error in the data payload. Notably, the error detection function is, for example, an even parity bit error control function or an odd even parity bit error control function. Thus, the data is hard-encrypted by using the combination of the encryption function, the obfuscation function, and the error detection function, thereby ensuring errorless as well as secure SMS communication. In such a case, where the plurality of layers employs the combination of the encryption function, the obfuscation function, and the error detection function, the data map provides information indicative of the combination that includes the encryption function, the obfuscation function, and the error detection function in each layer of the plurality of cascading layers to enable corresponding inverse layer-by-layer decryption, de-obfuscation, and the error detection function of the hard-encrypted data payloads.

According to an embodiment, the plurality of layers are cascaded layers, in which a ciphered output of a first layer is further ciphered in a second layer in the plurality of layers, wherein each layer employs a combination of the encryption function, the obfuscation function, and the error detection function. In an example, there are four layers in the plurality of layers as the cascaded layers. The ciphered output of the first layer (for example, an innermost layer) is further ciphered in the second layer. Furthermore, the ciphered output of the second layer is ciphered in the third layer, and so forth.

Moreover, the second given device has a key wallet in which the encryption function in each layer of the plurality of layers are defined according to a first index, and the obfuscation function in each layer are defined according to a second index. The data map further includes references to the first index and the second index such that the given second device requires use of the key wallet to interpret the first index and second index to enable the corresponding inverse layer-by-layer decryption and de-obfuscation of the hard-encrypted data payloads of the SMS messages communicated to the second given device. Referring to the abovementioned example, there are four layers in the plurality of layers as the cascaded layers. The inverse layer-by-layer decryption and de-obfuscation implies that firstly, the ciphered output of the fourth layer is deciphered. Further, the ciphered output of the third layer is deciphered. Furthermore, the ciphered output of the second layer is deciphered. Lastly, the ciphered output of the first layer is deciphered. Optionally, the first index may indicate which decryption technique to select. Accordingly, and optionally, the second index potentially indicates in what manner de-obfuscation needs to be done. In other words, index points out to select certain specific function from a specified list. According to an embodiment, the data map is encrypted when communicated from the first given device to the second given device via a data communication network. For example, the data map can be sent as a leading SMS message in a sequence of SMS messages, wherein the leading SMS message includes wallet indexes for decryption keys that are required for decrypting at the given recipient as well as a definition of obfuscation functions employed, wherein the leading SMS message includes wallet indexes for obfuscation functions that are required for decrypting at the given recipient. In another example, the data map can be sent as a trailing SMS message in a sequence of SMS messages, wherein the trailing SMS message includes wallet indexes for decryption keys that are required for decrypting at the given recipient as well as a definition of obfuscation functions employ, wherein the trailing SMS message includes wallet indexes for obfuscation functions that are required for decrypting at the given recipient. Alternatively, the data map is potentially sent as a part of header of any intermediate SMS message. Thus, any third party eavesdropping on the hard-encrypted data payload, even having intercepted the leading SMS message or the trailing SMS message, or other intermediate message would not be able to decrypt the payload unless the third party can guess how the data map is to be correctly processed.

As a first option, the hard-encrypted data payload is spread over multiple SMS messages; in other words, a large payload of data is communicated via SMS by dividing the large payload of data into smaller data fragments and then encrypting and obfuscating the data fragments to generate individual data payloads for SMS messages. As a second option, alternatively, a large payload of data is communicated via SMS by encrypting and obfuscating the large payload of data to generate corresponding hard-encrypted data, and the dividing up the corresponding hard encrypted data into fragments that are used as hard-encrypted payloads in a series of SMS messages. Optionally, only a single layer of encryption and obfuscation is employed. Alternatively, the plurality of layers of encryption and obfuscation are employed. It will be appreciated that the data map is sent, in one example, in a leading SMS message, which defines a number of SMS messages including the data payloads following in subsequent SMS messages.

According to an embodiment, the data map associated with the plurality of cascading layers is provided in a user data header (UDH) of a SMS message of a concatenated string of SMS messages, from the first given device to the second given device, wherein the data map in the UDH SMS message has corresponding indices referring to the key wallet present on the second device. At the given recipient, such as the given second device, the leading SMS message or the trailing SMS message (or other intermediate SMS message) is received and optionally decrypted to generate the data map. The sequence of SMS messages that follow thereafter, namely with hard-encrypted data payloads, are stored in data memory of the given second device. Furthermore, an inverse of the obfuscation functions and the encryption functions, according to the data map, are employed to generate the data payloads in original form, thereby reconstituting the large payload of data as originally present/communicated at (or by) the sender (for example, the first given device).

Optionally, when large payloads of data are to be communicated end-to-end in a very hard encrypted form, the SMS messages with their encrypted payloads are potentially hard-encoded to mutually different degrees. For example, in the large payload of data, a first portion of the large payload of data is hard encrypted using only “n” layers of encryption and obfuscation, whereas a second portion of the large payload of data is hard encrypted using “m” layers of encryption and obfuscation, wherein m>>n. For example, n=2, and m=200. In a practical use situation, a password or a PIN code is very hard encrypted with “m” levels of hard-encryption, whereas general banking advisory information would be less personally sensitive information and would be hard-encrypted with “n” levels of hard encryption. In an event that one of the SMS messages with a hard-encrypted payload becomes lost or missing in the data communication system, a request is potentially sent back from the given second device to the given first device to resend the missing SMS message. Moreover, in order to increase robustness yet further against a third-party interception, handshaking dialogue is implemented between the sender and the recipient to authenticate their identities, before the hard-encrypted data payloads are communicated between the sender and the recipient as aforementioned provided that the sender and the recipient have authenticated their identity.

Furthermore, authentication is achieved, for example, by the sender (i.e. the first given device) communicating, via a prompting SMS message, one or more parameters for a mathematical task. On receipt of the prompting SMS message, the one or more parameters are input to an algorithm, that is native or earlier downloaded to the recipient, that processes the one or more parameters to generate one or more output results. The given recipient then sends the one or more output results back to the sender for verification. If the given sender finds that the mathematical task has been performed correctly, an identity of the recipient device is thereby confirmed. Conversely, if no response is received from the recipient device within a time duration, or the one or more outputs are incorrect, the given sender determines thereby that the recipient is not authentic and does not send the hard-encrypted data to the recipient.

The present disclosure thereby provides the end-to-end ciphering via SMS in a manner that even the most powerful supercomputers would not be able to break. Even potential quantum computing engines would have difficulty breaking the end-to-end ciphering in the multi-layered mechanism as proposed in the present disclosure.

According to an embodiment, the key wallet is stored in a secured form in the second given device, wherein the secured form corresponds to at least one of a secured physical area in a memory of the second given device or an encrypted form of the key wallet, or a combination of the secured physical area and the encrypted form of the key wallet. The secure physical area in the memory of the second given device is for example, a secure element employed within the second given device. The key wallet comprises sensitive information related to the first index associated with the encryption functions and the second index associated with the obfuscation function. Thus, the secure element safeguards such sensitive information therewith. The secure physical area acts as a vault and protects the information therewith from malicious codes or software. The key wallet can also be stored in the encrypted form outside of the secure physical area in the second given device to keep the key wallet protected. The combination of the secured physical area and the encrypted form of the key wallet may also be used to safeguard the key wallet from unwanted access. However, in an event that the secured physical area become hacked, software of the second given device detects that a change in software has occurred and sends a message to the first given device that a security of the second given device for hard-encrypted data has been compromised.

According to an embodiment, the data communication system supports, when in operation, data communication therethrough using Transmission Control protocol/Internet Protocol TCP/IP. The end-to-end encryption of the present disclosure is optionally employed with conventional SMS messaging services, or TCP/IP-based SMS messaging services as described in the present disclosure wherein delivery of the SMS messages is acknowledged from the given recipient, allowing for auditing and traceability. The given device and/or the data communication system includes at least one signalling layer through which is communicated a confirmation of a given signalling event delivering an SMS to the given device via use of Transmission Control protocol/Internet Protocol TCP/IP has been successfully executed, wherein the confirmation is used to make an execution of the given signalling event auditable and traceable. Optionally, the data communication system facilitates sending of conventional short messaging service (“SMS”) through TCP/IP to a given device. The SMS optionally originates from a communication device, which optionally include smartphones of individual users, or computing devices of one or more businesses.

Optionally, a signalling layer is a secure communication “tunnel” that is created across one or more communication nodes between a given device, such as the given second device, and a communication device, such as the given first device. The signalling layer is, for example, defined by one or more communication protocols. The signalling layer, for example, facilitates transmission of the confirmation of a given signalling event from the given device to the communication device, in a secure manner, such as by encryption. The one or more communication nodes, for example, include an active electronic device that is connectable (i.e. communicatively coupled) to the data communication system, and is capable of creating, receiving, or transmitting information over a communications channel of the data communication system. For example, the one or more communication nodes include modems, routers, switches and other network equipment.

Optionally, the secure communication “tunnel” is created by first authenticating a given device, a communication device, and the one or more communication nodes with a communication server. For example, a software application is installed on the communication server that authenticates the given device, the communication device, and one or more communication nodes on the communication server. Furthermore, the communication server optionally makes use of one or more encryption protocols to make sure that the confirmation sent from the given device is not susceptible to being monitored/altered by external entities, and is beneficially secure. Accordingly, the confirmation is beneficially transmitted securely through the secure communication “tunnel”.

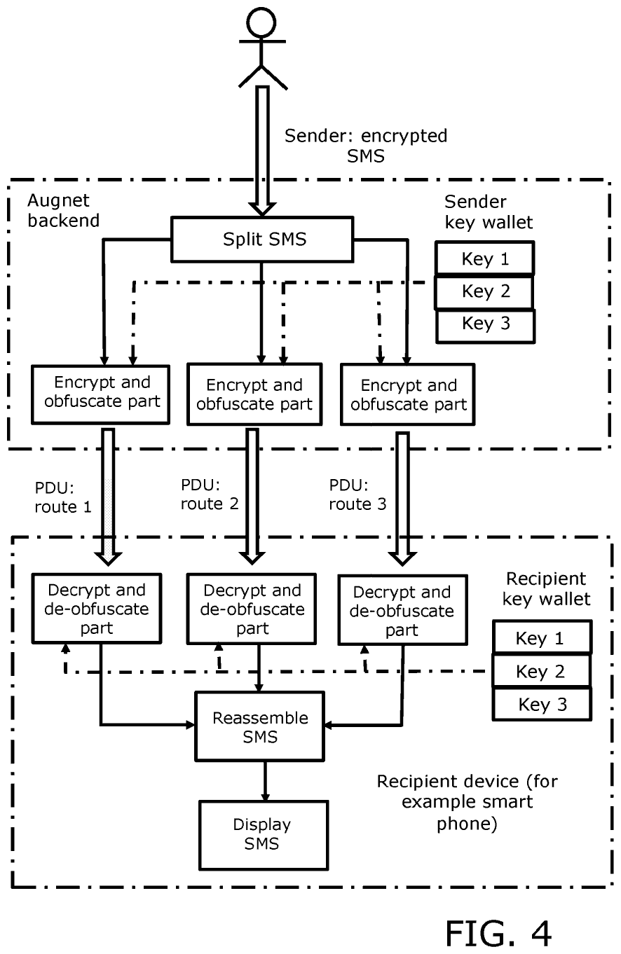

As illustrated in FIG. 4, when hard-encrypted SMS communications are communicated from a given sender to a given recipient, parts of a given hard-encrypted SMS communication are communicated via different SMS communication routes, such that it is very difficult for a malicious third party to monitor all of the different SMS communication routes to try to reconstitute the hard-encrypted SMS communication. If the malicious third party intercepts a mid-portion of the hard-encrypted SMS communication that is devoid of the user data header (USD), the malicious third party will not have any information regarding indices that control which decryption functions and which de-obfuscation functions are to be used to interpret the mid-portion.

Furthermore, optionally, a software application is installed on one or more devices, namely by injection of application code into the middleware layer, the communication device, and the one or more communication nodes. Any communication between the software application installed in the middleware level of the one or more devices, the communication device, and the one or more communication nodes is optionally performed using one or more protocols as defined in the signalling layer.

According to an embodiment, the data communication system is operable to transcode a SMS communication of a SMS message event into Internet® Protocol (IP) data packets that are delivered to the given device, wherein receipt of the Internet® Protocol (IP) data packets at the given device causes the given user device to send the confirmation as an acknowledgement of receipt of the Internet® Protocol (IP) packets so that the execution of the given signalling event is auditable and traceable. In an example, even if an intermediate payload is not received at the recipient (i.e. the second given device), a request is potentially sent from the second given device to retrieve the lost intermediate payload. Its only after receipt of all payloads originally communicated that the confirmation of receipt is send to the sender (i.e. the first given device).

According to an embodiment, transcoding the SMS message includes changing a language and/or a protocol of the SMS message. For example, the language is related to a particular codec used for the SMS message. Furthermore, optionally, a protocol of the SMS message is changed to IPv4 protocol to obtain an IPv4 data packet. More optionally, transcoding the conventional SMS message includes changing a packet format of a conventional SMS message to an IP message packet format. For example, the packet format of the SMS message is changed to the IPv4 packet format. For example, the packet format of the SMS message includes one or more SMS packet parameters such as a Service Centre Address information element (SCA), an Originator Address (OA), a Destination Address (DA), a Protocol Identifier (PID), a Data Coding Scheme (DCS), a Service Centre Time Stamp (SCTS), a Validity Period (VP), a User Data Length (UDL), and a User Data (UD). Furthermore, optionally, the SCA defines a telephone number of a service centre (center). The OA optionally defines an address of an originating SME. The DA defines an address of the destination SME, and the PID is a parameter defining a manner of processing the SMS message, such as a FAX message, voice message, and so on. Furthermore, the DCS identifies the coding scheme within a user data (UD), as specified by the user. The SCTS identifies a time when an SMSC (such as an intermediary communication node) has received the message. The VP identifies the time from where the SMS message is no longer be valid in the SMSC. Furthermore, the UDL indicates the length of the field where the user has entered the data of the SMS message, and the UD defines the data or the content, such as a text, of the SMS message.

For example, one or more IP packet parameters in the packet format of IP packet includes a version field, IP header length (IHL) field, type-of-service field, total length field, a flags field, a time-to-live field, a source address field a destination address field and an options field. The version field beneficially indicates a version of the IP packet used. The IHL field indicates how many 32-bit words are in the IP packet header. The type-of-service field specifies how a particular upper-layer protocol would handle the current datagram, and may allow datagrams to be assigned various levels of importance. The total length field specifies a length of the entire IP packet, including data and header, in bytes. The flags field controls how a packet is fragmented, and indicates the parts of the IP packet to a receiver. The time-to-live field maintains a counter that gradually decrements to zero, at which point the datagram is discarded. The source address field specifying a sending communication node. The destination address field specifies a receiving communication node. The options field enables the IP packet to support various options, such as security.

Accordingly, transcoding optionally includes transforming one or more data/values corresponding to the one or more SMS parameters into the one or more data/values corresponding to the one or more IP packet parameters according to predefined rules. For example, data/value corresponding to the Validity Period (VP) parameter in the SMS packet are transformed into data/value corresponding to the time-to-live field of the IP packet. Alternatively, if the one or more parameters in the packet format of the SMS message do not correspond to one or more parameters in the packet format of the IP packet, the value of the one or more parameters in the packet format of the IP packet may be set to a default value. Optionally, in the data communication system, the conventional SMS communication is transcoded in operation via an application programming interface (API) or an operating system functionality hosted by the data communication system and/or the given device.

According to an embodiment, the SMS communication is transcoded in operation via use of a centrally stored database, wherein the database includes a list of accessible telephone numbers that are reachable by the one or more software applications for delivering the IP data packets of the transcoded SMS message to the given device. For example, the one or more software applications for delivering the IP packets of the transcoded SMS message to the given device includes software applications such as Uber®. The one or more software applications optionally require a user to provide an accessible telephone number, such as to receive a confirmation message to complete the registration.

According to an embodiment, an online application of the data communication system, in operation, receives the IP data packets generated by transcoding the conventional SMS communication, and delivers the IP data packets to a user-selected or default SMS application of the given device. For example, the user-selected or default SMS application of the given device includes iMessage®, Hangouts® and TrueMessenger®.

According to an embodiment, the given device is implemented as a mobile wireless communication device (e.g. smart phone) which employs a background process to authenticate a messaging application programmable interface (API) executing as a cloud service in the data communication system. The application programmable interface sends, in operation, a telephone number or a device identification to a database for storing therein, wherein the database is hosted within the cloud service. Optionally, the background process runs through one or more software applications installed on the given device. The one or more software applications accesses the default, or messaging software application installed on the given device wherein injection of application code into the middleware layer is undertaken, and determines the receipt of the transcoded SMS message. As described in the foregoing, injection of the application code into the middleware layer overwrites the default, or disables the default in preference of the injected application code.

According to an embodiment, a registration of the given device involves installing an application (“App”) that reads a device indication of the given device, wherein the device indication is then communicated within the data communication system using a push notification. The push notification is used to communicate to the user of the given device that a given transcoded SMS message is available, wherein the given device receives the transcoded SMS message via use of the IP data packets and sends the confirmation that the transcoded SMS message has been delivered.

According to an embodiment, the transcoded SMS message is received by a plurality of applications or operating layers of the device, and delivery of the transcoded SMS message is confirmed to have occurred when at least one of the plurality of APP or operating layers of the device have delivered the transcoded SMS message to a user of the given device. Optionally, the application installed on the given device to provide an indication about the receipt of the given transcoded SMS message monitors additional parameters, such as network connectivity. Furthermore, optionally, the application installed on the given device to provide an indication about the receipt of the given transcoded SMS is also in contact with one or more online applications/nodes sending the transcoded SMS message through one or more IP data packets. Accordingly, if a transcoded SMS message is not received partially or completely due to a loss of one or more IP data packets due to high network latency, the application installed on the given device queries the one or more online applications/nodes sending the transcoded SMS message to resend the transcoded SMS message to the given device. More optionally, in the data communication system, the APP also displays the transcoded SMS message to the user of the given device. Yet more optionally, in the data communication system, the transcoded SMS message is received by a plurality of APP or operating layers of the device, and delivery of the transcoded SMS message is confirmed to have occurred when at least one of the plurality of APP or operating layers of the device have delivered the transcoded SMS message to a user of the given device. The confirmation includes an indication of an associated mobile number of the given device at which one or more IP packets corresponding to a transcoded SMS has been received. Furthermore, optionally, the confirmation includes an indication of a time at which the one or more IP packets corresponding to the transcoded SMS have been received at the given device. Furthermore, optionally, the confirmation includes an identifier of the SMS message that has been transcoded, and transmitted to the given device. For example, if multiple IP packets corresponding to multiple transcoded SMS messages are sent to the given device, the confirmation of one or more of the multiple transcoded SMS messages include the identifier related to a particular transcoded SMS message. Accordingly, the signalling event is beneficially auditable and traceable. Furthermore, the confirmation is beneficially decrypted, audited and traced at the communication device, or the one or more communication nodes.

Next, in overview, it will be appreciated that the present disclosure also discloses a method of (for) providing encrypted end-to-end communication for SMS messaging services that is extremely robust against eavesdropping, wherein the method employs one or more layers of encryption and obfuscation in combination with a data map that, for example, is also communicated via the SMS messaging service. The one or more layers of hard encryption makes hard-encrypted data payloads of the SMS messages impossible to break, even using some of the most powerful contemporary supercomputers, for example as employed by national security agencies.

The present disclosure also relates to the method as described above. Various embodiments and variants disclosed above apply mutatis mutandis to the method.

According to an embodiment, the method comprises employing a combination of the encryption function, the obfuscation function, and further a parity bit error control function in each layer of the plurality of layers, wherein the data map provides information indicative of the combination that includes the encryption function, the obfuscation function, and further the parity bit error control function in each layer of the plurality of cascading layers to enable corresponding inverse layer-by-layer decryption, de-obfuscation, and a parity check of the hard-encrypted data payloads of the SMS communications at the second given device.

Next, in overview, the present disclosure provides a computer program product comprising a non-transitory computer-readable storage medium having computer-readable instructions stored thereon, the computer-readable instructions being executable by a computerized device comprising processing hardware to execute the aforementioned method.

### DETAILED DESCRIPTION OF THE DRAWINGS

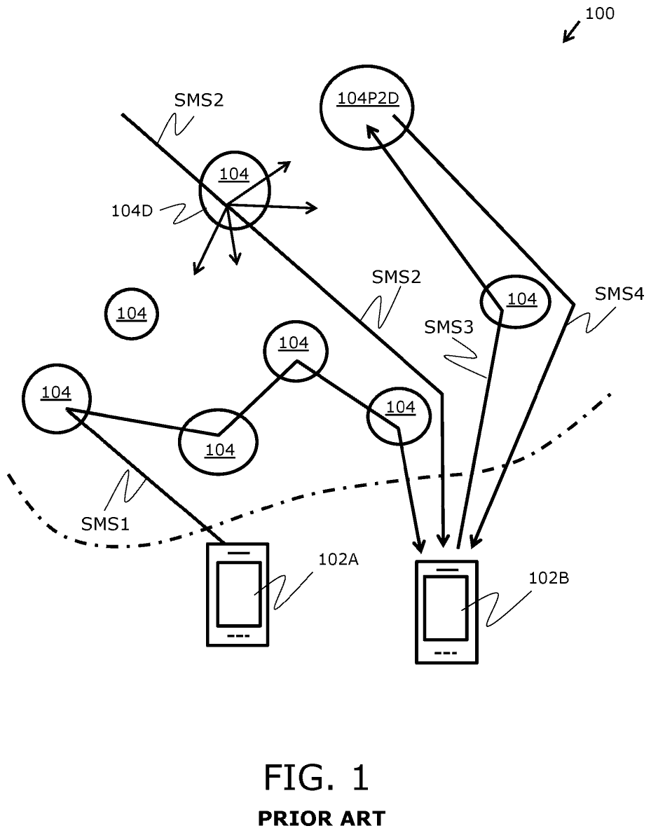

Referring to FIG. 1, there is illustrated a prior art depicting a conventional data communication system 100 that communicates conventional SMS messages to user devices. The conventional data communication system 100 includes mobile communication devices 102A, 102B. The data communication system 100 includes a plurality of communication nodes 104 that are coupled to exchange data therebetween in operation. In a conventional manner of sending an SMS message, a user of the mobile communication device 102A types in a short text message that is communicated as an SMS message, referred to as “SMS1”, via nodes 104 to the mobile communication device 102B; the nodes 104 merely make a “best attempt” to try to deliver the SMS1 but are vulnerable to hacking or sniffing by a miscreant.

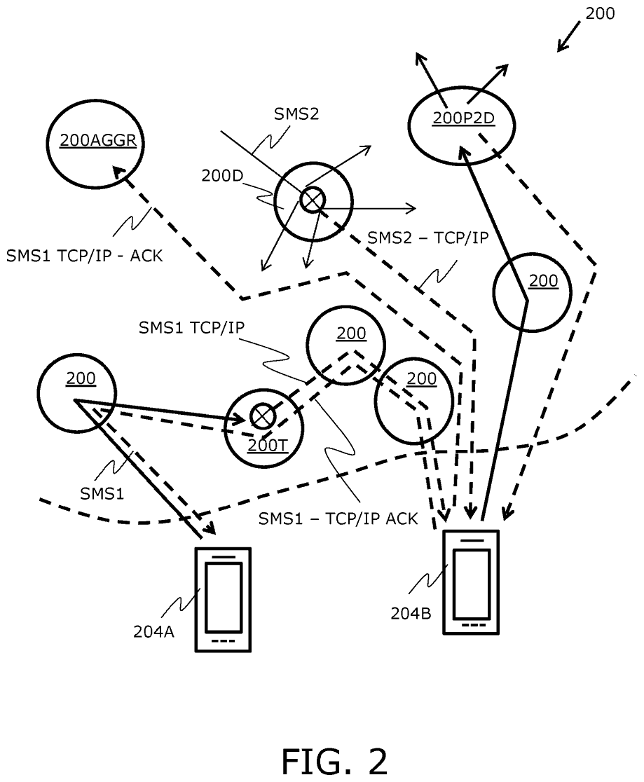

In the conventional data communication system 100 of FIG. 1, there are also SMS suppliers, for example associated with a node 104D that provides a service to distribute an SMS message “SMS2” to mobile communication devices 102A and other such devices; from the node 104D, the SMS2 message is supplied to the mobile communication device 102B; no confirmation message is sent back from the mobile communication device 102B to the node 104D, so a customer of the service provided by the node 104D cannot be certain that the node 104D is successfully managing to deliver the SMS2 message (for example, an advertisement) successfully to the mobile communication device 102B and other relates types of communication devices coupled to the data communication system 100. There is therefore, a risk that an operator of the node 104D takes payment from its customer, even despite not performing correctly to deliver the SMS2 message to communication devices coupled to the data communication system 100. Additionally, in the conventional data communication system 100 of FIG. 1, the user of the mobile communication device 102B sends an SMS message “SMS3” to a node 104P2D that hosts a process “P”. The process “P” automatically generates, in response, an SMS message “SMS4” that is to be communicated back to the mobile communication device 102B. However, on account of a lack of confirmation of receipt of the SMS message SMS4 at the mobile communication device 102B, the process “P” is uncertain the whether or not the SMS message SMS4 has been successfully received at the mobile communication device 102B. Referring to FIG. 2, there is illustrated a data communication system 200 that securely communicates SMS messages to user devices, in accordance with an embodiment of the present disclosure. The data communication system 200 includes a first given device 204A (e.g. a mobile communication device) that sends a SMS communication SMS1 to a node 200 that passes SMS1 to a node 200T. Notably, the nodes 200 of FIG. 2 corresponds to the nodes 104 of FIG. 1. The node 200T transcodes the SMS1 from a conventional SMS format to a TCP/IP format (for example, to a VoIP format) to provide a TCP/IP equivalent message SMS1-TCP/IP. “Transcoding” in this context relates to a change of language and/or protocol of the message SMS1 to generate the TCP/IP equivalent message SMS1-TCP/IP; such transcoding is conveniently achieved using an API at the node 200T. The TCP/IP equivalent message SMS1-TCP/IP is communicated via a plurality of nodes 200 to be received at a second given device 204B (e.g. a mobile communication device), in TCP/IP format. However, it will be appreciated that TCP/IP allows an operating layer, software application or API hosted in the second given device 204B to generate a confirmation-of-receipt message SMS1-TCP/IP-ACK that is communicated back to the first given device 204A, confirming that the SMS message SMS1 has been received at the second given device 204B.

For the node 200D providing an SMS delivery service, the SMS message SMS2 is transcoded, for example as aforementioned, to an equivalent message SMS2—TCP/IP that is delivered to the second given device 204B via use of TCP/IP protocol. The second given device 204B generates a confirmation message in TCP/IP format that is communicated back to, for example, a data aggregating node 200AGGR that logs successfully received messages handled via the node 200D, for example for financial auditing purposes to monitor a quality of SMS delivery service provided by the node 200D. In respect of process-to-device messaging, the second given device 204B transcodes therein an SMS message SMS3 to TCP/IP format as SMS3-TCP/IP and then communicates the message SMS3-TCP/IP via node 200 to a process node 200P2D. A process “P” executing at the process node 200P2D send back a message SMS4-TCP/IP in TCP/IP format via the node 200 to the second given device 204B. Optionally, the second given device 204B sends a confirmation SMS message in TCP/IP format back to the process node 200P2D or elsewhere in the data communication system 100 of FIG. 2, for example to a performance result aggregating node.

SMS messages sent from the first given device 204A to the second given device 204B are beneficially, at least partly, arranged to have their data payloads hard-encrypted using a plurality of layers, where each layer employs encryption and obfuscation functions as described in the foregoing. The second given device 204B has a key wallet that is addressable via key indexes included in one of the SMS message of a series of SMS messages that have hard-encrypted data payloads, wherein the SMS message that includes data map information is used to enable hard-encrypted data payloads of the series of SMS messages to be decrypted and de-obfuscated at the second given device 204B. The key wallet is stored in secured form in the second given device 204B for providing an extra level of safety and security.

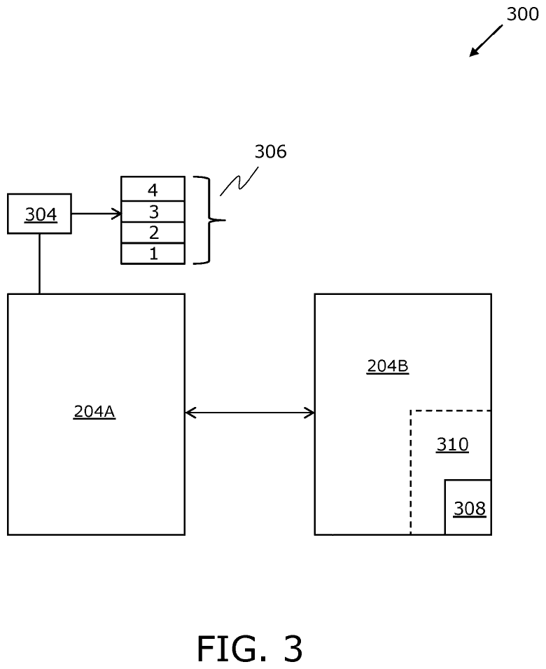

Referring to FIG. 3, there is illustrated a block diagram of a data communication system, in accordance with an embodiment of the present disclosure. As shown, the data communication system 300 comprises the first given device 204A and the second given device 204B. The SMS communications are end-to-end ciphered in the data communication system 300 when communicated from a first given device 204A to a second given device 204B. The data payloads 304 of at least a subset of the SMS communications are hard-encrypted by a plurality of layers 306 at the first given device 204A. Each layer is a combination of an encryption function and an obfuscation function. Furthermore, a data map is associated with the plurality of layers 306 and is provided in a SMS message from the first given device 204A to the second given device 204B. Furthermore, the data map provides information indicative of the combination in each layer of the plurality of layers to enable corresponding inverse layer-by-layer decryption and de-obfuscation of the hard-encrypted data payloads 304 of the SMS messages at the second given device 204B. As shown, there are four layers, numbered “1”, “2”, “3” and “4” in the plurality of layers 306 as the cascaded layers. The ciphered output of the first layer “1”, e.g., an innermost layer is further ciphered in the second layer “2”. Furthermore, the ciphered output of the second layer “2” is ciphered in the third layer “3”. Similarly, the ciphered output of the third layer “3” is ciphered again in the fourth layer “4”. Thus, the ciphered output of the first layer “1” is ciphered four times, the ciphered output of the second layer “2” is ciphered thrice, the ciphered output of the third layer “3” is ciphered twice and the ciphered output of the fourth layer “4” is ciphered once. The inverse layer-by-layer decryption and de-obfuscation implies that firstly, the ciphered output of the fourth layer “4” is deciphered. Furthermore, the ciphered output of the third layer “3” is deciphered. Furthermore, the ciphered output of the second layer “2” is deciphered. Lastly, the ciphered output of the first layer “1” is deciphered. Moreover, the second given device 204B has a key wallet 308 in which the encryption function in each layer of the plurality of layers 306 are defined according to a first index, and the obfuscation function in each layer are defined according to a second index. Optionally, the key wallet 308 is stored in a secured form in the second given device 204B. The secured form corresponds to at least one of a secured physical area 310 in a memory of the second given device 204B or an encrypted form of the key wallet 308, or a combination of the secured physical area 310 and the encrypted form of the key wallet 308. The data map further includes references to the first index and the second index such that the given second device 204B requires use of the key wallet 308 to interpret the first index and second index to enable the corresponding inverse layer-by-layer decryption and de-obfuscation of the hard-encrypted data payloads 304 of the SMS messages communicated to the second given device 204B.

Referring to FIG. 4, there is shown an illustration of the data communication system 300 of FIG. 3, wherein portions of a hard-encrypted SMS message, for example a concatenated series of SMS messages, are communicated via mutually different communication routes to reduce a risk of malicious third-party eavesdropping.

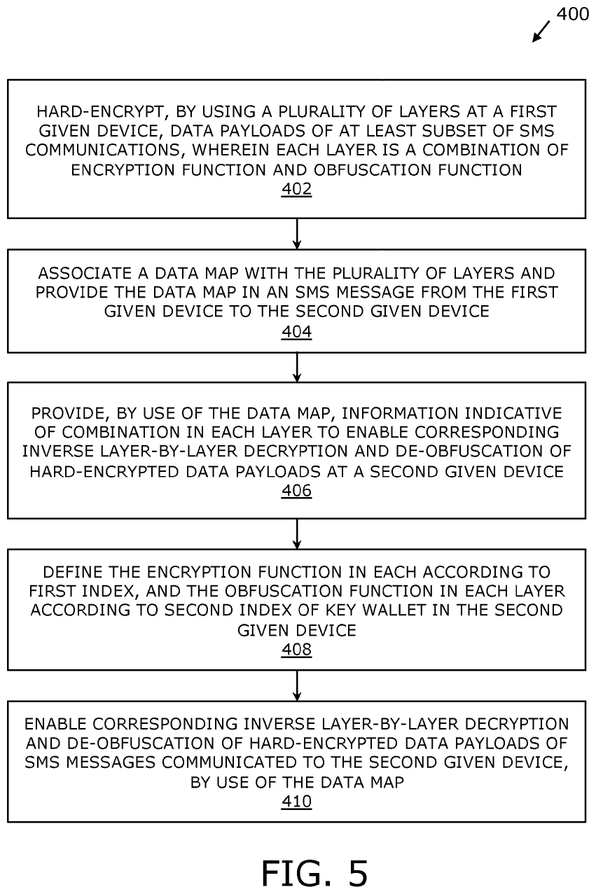

Referring to FIG. 5, there is illustrated a flow chart 400 of a method of (namely, a method for) operating a data communication system, in accordance with an embodiment of the present disclosure. The method includes arranging for the SMS service communications to be end-to-end encrypted in the data communication system when communicated from a first given device to a second given device.

As shown, at a step 402, data payloads of at least a subset of the SMS communications are hard-encrypted by using a plurality of layers at a first given device, wherein each layer is a combination of an encryption function and an obfuscation function. At a step 404, a data map is associated with the plurality of layers and the data map is provided in a SMS message from the first given device to the second given device. At a step 406, information indicative of the combination in each layer of the plurality of layers is provided, by use of the data map, to enable corresponding inverse layer-by-layer decryption and de-obfuscation of the hard-encrypted data payloads of the SMS messages at the second given device. At a step 408, the encryption function in each layer of the plurality of layers are defined according to a first index, and the obfuscation function in each layer are defined according to a second index of a key wallet in the second given device. At a step 410, corresponding inverse layer-by-layer decryption and de-obfuscation of the hard-encrypted data payloads of the SMS messages communicated to the second given device is enabled, by use of the data map that further includes references to the first index and the second index such that the given second device requires use of the key wallet to interpret the first index and second index.

Thus, according to embodiments of the present disclosure, the disclosed data communication system and method further include features, which are:
(i) operating systems of the mobile communication devices 102A, 102B and/or nodes of the data communication system 100 allow other apps to access an SMS app; and
(ii) operating systems or apps (such as Skype®, Uber® and so forth) allow running of an API query with them to check an accessibility of a mobile telephone number that has been verified on their respective platforms; the apps allow for embedded code therein, for example subject to verification of the embedded code.

Embodiments of the present disclosure are an only SMS offering service that can guarantee and prove 100% message delivery with high security. Furthermore, by using a hybrid SMS & IP network, costs of delivering SMS-type short message is cheaper than any traditional SMS network (namely, cheaper than 100% of the presently established SMS industry, as aforementioned).

Embodiments of the present disclosure beneficially employ a network layer signalling event that confirms that a given SMS-type message has been delivered. This is the only way to confirm when messages have been delivered to intended destination communication devices. There is thereby provided an SMS delivery service that is auditable and traceable, in contradistinction to conventional SMS as aforementioned with reference to FIG. 1.

When a traditional SMS is delivered, there is usually a signalling event that takes place (either a handset delivery report or a network delivery report). An issue is that these delivery reports can be generated by a carrier grade switch. Because anyone can generate a delivery report (even when the message has been killed), the trust in these reports is very low. It is conventionally impossible to verify which switch generated the delivery message (technical problem: falsification of conventional SMS delivery reports).

In embodiments of the present disclosure, there is effectively performed conventional SMS communications, wherein the transcoding takes out convention SMS communications from their SMS environment. When a given SMS message is sent to a given recipient device:
(i) a service pursuant to the present disclosure tries to locate a mobile communication device for which the given SMS is destined for; such locating is achieved by employing by using either of method 1 or method 2 as follows:
   Method 1: using an API: any Operating systems or APP's that have signed up to the service are contacted and a query run to ascertain whether or not a particular mobile number is reachable, that determine that required push notifications are active; or
   Method 2: a centrally stored database is maintained in the data communication system 100, wherein the database has stored therein a list of accessible numbers that are reachable by various apps;
(ii) assuming one of the methods 1 and 2 above return a positive affirmative result, the service then transcodes from the traditional SMS protocol/codec employ for the given SMS message, and into the required IP/data packets for communicating the given SMS message via TCP/IP protocol; and
(iii) the successful/online app will then covertly receive the data packets containing the given SMS, and will deliver the data packets to the native SMS app on the device. A native SMS client can also mean the preferred messaging client that the user has selected.

All of this (i) to (iii) happens without a receiving party knowing that an SMS has arrived via a different delivery method, namely is not aware of transcoding having been employed. Ideally, the transcoded given SMS presented on a user's communication device is available a plurality of times in several apps.

Embodiments of the present disclosure make is possible to bypass SMS termination rates of conventional SMS delivery systems, and gain more data/intelligence as to the delivery of messages, for example auditing purposes.

In embodiments of the present disclosure, a background process runs on a given user's smart phone which authenticates to a messaging API running as a cloud service. This background process sends in operation the user's phone number and their device id that is then stored in a database within the cloud; it will be appreciated that permission would have to have been provided on APP installation. The user's phone number and device id are stored in a database; no other identifying information is required. Such a manner of operation is desirable because there are less stringent regulations on privacy when personal details are not stored.

When a subscribing aggregator using this service wishes to send an SMS to a user, they call an API endpoint running in a cloud service. An aggregator then provides the message and the phone number to whom they wish to send the message. The API looks up the phone number in a database and one of the following two scenarios then occurs:
1. Scenario 1: their number is found, thus the user has installed the APP and registered with the service. Based on this scenario, the following steps occur:
   (a) The Device ID is read from the record and is used to send a push notification to the device using, for example, Azure Notification Hub®;
   (b) The device receives the push notification to inform that a message is available. The background process wakes up, and makes an API call to a service to retrieve the message;
   this allows unlimited payloads rather than using the small payload of a push notification. When the device receives the message, it sends an acknowledgement and that message then gets marked as delivered;
   (c) The billing system records the transaction, which is then optionally used to invoice the subscriber of the service; and
   (d) The APP displays the message to the user within the default messaging client on the device; such a default is, for example, messaging client most often employed by the user, or a messaging client that is selected by the user.
2. Scenario 2: the number is not found, based on this scenario the following steps occur:
   (a) the message is sent via SMS utilizing an SMS provider; and
   (b) a record of the transaction is recorded so that the subscriber can be informed regarding which users are not using the service.

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for items, components or elements not explicitly described also to be present. Reference to the singular is also to be construed to relate to the plural.

1.-26. (canceled)

27. A data communication system that, when in operation, sends short messaging service (SMS) communications to one or more devices, wherein the SMS communications are end-to-end ciphered in the data communication system when communicated from a first given device to a second given device, wherein data payloads of at least a subset of the SMS communications are hard encrypted by a plurality of layers at the first given device, wherein each layer is a combination of an encryption function and an obfuscation function, and wherein a data map is associated with the plurality of layers and is provided in a user data header (UDH) of a SMS message from the first given device to the second given device, and wherein the data map provides information indicative of the combination in each layer of the plurality of layers to enable corresponding inverse layer-by-layer decryption and de-obfuscation of the hard-encrypted data payloads of the SMS communications at the second given device, and wherein the second given device has a key wallet in which the encryption function in each layer of the plurality of layers are defined according to a first index, and the obfuscation function in each layer are defined according to a second index, and wherein the data map in the UDH of the SMS message further includes references to the first index and the second index such that the given second device requires use of the key wallet to interpret the first index and second index to enable the corresponding inverse layer-by-layer decryption and de-obfuscation of the hard-encrypted data payloads of the SMS messages communicated to the second given device.

28. A data communication system of claim 27, wherein the key wallet is stored in a secure data area of the second given device that has restricted access from software residing in the second given device.

29. A data communication system of claim 27, wherein the key wallet is generated by executing software that is included in an operating system of the second given device upon initial registration of the second given device.

30. A data communication system of claim 27, wherein at least one of the first given device and the second given device is a mobile communication device (for example, a smart phone) wherein executable software installed in the mobile communication device to process the end-to-end ciphered SMS communications is an integral part of an operating system (for example, Android®, iPhone OS, MeeGo OS, Symbian OS, webOS, Blackberry OS) of the mobile communication device.

31. A data communication system of claim 27, wherein the plurality of layers employ mutually different encryption functions or mutually different encryption keys, or both.

32. A data communication system of claim 27, the plurality of layers employ mutually different obfuscation functions or mutually different obfuscation templates, or both.

33. A data communication system of claim 27, one or more layers of the plurality of layers employs a combination of the encryption function, the obfuscation function, and further error detection function, wherein the data map provides information indicative of the combination that includes the encryption function, the obfuscation function, and further the error detection function in the one or more layers of the plurality of layers to enable corresponding inverse layer-by-layer decryption, de-obfuscation, and a error detection check of the hard-encrypted data payloads of the SMS communications at the second given device.

34. A data communication system of claim 27, wherein the data map is encrypted when communicated from the first given device to the second given device via a data communication network.

35. A data communication system of any one of claim 27, wherein the first given device is a mobile telephone and the second given device is a server arrangement of a banking institution, wherein the end-to-end ciphered SMS communications are used to implement financial transactions at the banking institution.

36. A data communication system of claim 27, wherein the data map associated with the plurality of layers is provided in the user data header (UDH) of a SMS message of a concatenated string of SMS messages, from the first given device to the second given device, wherein the data map in the UDH SMS message has corresponding indices referring to the key wallet present on the second device.

37. A data communication system of claim 27, wherein the key wallet is stored in a secured form in the second given device, wherein the secured form corresponds to at least one of a secured physical area in a memory of the second given device or an encrypted form of the key wallet, or a combination of the secured physical area and the encrypted form of the key wallet.

38. A data communication system of claim 27, wherein the plurality of layers are cascaded layers, in which a ciphered output of a first layer is further ciphered in a second layer in the plurality of layers, wherein each layer employs a combination of the encryption function, the obfuscation function, and a parity bit error control function.

39. A data communication system of claim 27, wherein the data communication system supports, when in operation, data communication therethrough using Transmission Control protocol/Internet Protocol (TCP/IP); and wherein a given device includes at least one signalling layer through which is communicated a confirmation of a given signalling event delivering an SMS to the given device via use of Transmission Control protocol/Internet Protocol TCP/IP has been successfully executed, wherein the confirmation is used to make an execution of the given signalling event auditable and traceable, wherein the given device is at least one of the first given device or the second given device.

40. A data communication system of claim 39, wherein the data communication system is operable to transcode a SMS communication of a SMS message event into Internet® Protocol (IP) data packets that are delivered to the given device, wherein receipt of the Internet® Protocol (IP) data packets at the given device causes the given user device to send the confirmation as an acknowledgement of receipt of the Internet® Protocol (IP) packets so that the execution of the given signalling event is auditable and traceable.

41. A data communication system of claim 40, wherein transcoding the SMS message includes changing a language and/or a protocol of the SMS message.

42. A data communication system of claim 40, wherein the SMS communication is transcoded in operation via use of a centrally stored database, wherein the database includes a list of accessible telephone numbers that are reachable by the one or more software applications for delivering the IP data packets of the transcoded SMS message to the given device.

43. A data communication system of claim 40, wherein an online application of the data communication system, in operation, receives the IP data packets generated by transcoding the conventional SMS communication, and delivers the IP data packets to a user-selected or default SMS application of the given device.

44. A data communication system of claim 27, wherein the given device is implemented as a mobile wireless communication device which employs a background process to authenticate a messaging application programmable interface (API) executing as a cloud service in the data communication system, and wherein the application programmable interface sends, in operation, a telephone number or a device identification to a database for storing therein, wherein the database is hosted within the cloud service.

45. A data communication system of claim 40, wherein a registration of the given device involves installing an application that reads a device indication of the given device, wherein the device indication is then communicated within the data communication system using a push notification, wherein the push notification is used to communicate to the user of the given device that a given transcoded SMS message is available, wherein the given device receives the transcoded SMS message via use of the IP data packets and sends the confirmation that the transcoded SMS message has been delivered.

46. A data communication system of claim 45, wherein the transcoded SMS message is received by a plurality of applications or operating layers of the device, and delivery of the transcoded SMS message is confirmed to have occurred when at least one of the plurality of applications or operating layers of the device have delivered the transcoded SMS message to the given device of a user.

47. A method of (A method for) operating a data communication system to send conventional short messaging service (“SMS”) communications to one or more devices, wherein the method includes: arranging for the SMS service communications to be end-to-end ciphered in the data communication system when communicated from a first given device to a second given device, wherein the SMS service communications are end-to-end ciphered by:
(i) hard-encrypting, by use of a plurality of layers at the first given device, data payloads of at least a subset of the SMS communications, wherein each layer is a combination of an encryption function and an obfuscation function;
(ii) associating, a data map with the plurality of layers and providing the data map in a user data header (UDH) of a SMS message from the first given device to the second given device;
(iii) providing, by use of the data map, information indicative of the combination in each layer of the plurality of layers to enable corresponding inverse layer-by-layer decryption and de-obfuscation of the hard-encrypted data payloads of the SMS communications at the second given device;
(iv) defining the encryption function in each layer of the plurality of layers according to a first index, and the obfuscation function in each layer according to a second index of a key wallet in the second given device, and
(v) enabling the corresponding inverse layer-by-layer decryption and de-obfuscation of the hard-encrypted data payloads of the SMS messages communicated to the second given device, by use of the data map provided in the UDH of the SMS message that further includes references to the first index and the second index such that the given second device requires use of the key wallet to interpret the first index and second index.

48. A method of claim 47, the method further comprises employing a combination of the encryption function, the obfuscation function, and further a parity bit error control function in each layer of the plurality of layers, wherein the data map provides information indicative of the combination that includes the encryption function, the obfuscation function, and further the parity bit error control function in each layer of the plurality of layers to enable corresponding inverse layer-by-layer decryption, deobfuscation, and a parity check of the hard-encrypted data payloads of the SMS communications at the second given device.

49. A computer program product comprising a non-transitory computer-readable storage medium having computer-readable instructions stored thereon, the computer readable instructions being executable by a computerized device comprising processing hardware to execute a method as claimed in claim 47.
